(19) United States
(12) Patent Application Publication
(10) Pub. No.: US 2003/0104827 A1
(43) Pub. Date: Jun. 5, 2003

(54) Rerouting/reformating wireless messages for cross connectivity between service providers

(76) Inventors: Brian Moran, Preston, WA (US); David Feinleib, Kirkland, WA (US); Chuck Mount, Kirkland, WA (US)

Correspondence Address: R. Alan Burnett, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/000,223

(22) Filed: Nov. 30, 2001

(51) Int. Cl. H04Q 7/20

(52) U.S. Cl. 455/466; 455/458

(57) ABSTRACT

A method and system that enables wireless device users to send messages from their devices to other wireless devices that use a different service provider than the sending device. Generally, the method and system are enabled through use of a third party rerouting/reformatting service that appears transparent to the wireless device users and service providers. In one embodiment, the method includes converting an original SMS message into an e-mail message and routing the e-mail message to the rerouting/reformatting service, whereupon the e-mail message is reformatted into a destination message that is dispatched for delivery to a destination device selected by a user who generated the original SMS message. In another embodiment, rerouting indicia is appended to an SMS message such that it is routed to the rerouting/reformatting service, which again performs reformatting and message dispatch functions to deliver the message to a selected destination device.

### BACKGROUND OF THE INVENTION

1. Field of the Invention

The present invention generally concerns wireless messaging services, and in more particular concerns a method and system for rerouting and reformatting messages so that users can send messages to other users that use different wireless service providers.

2. Background Information

Under the present wireless bandwidth allocation scheme in the United States, there are several wireless service providers for each metropolitan market, and generally at least two service providers for rural markets. Unlike other areas of the world, such as Europe, the various service providers for a given U.S. market generally do not provide text messaging cross-compatibility with other service providers in that market. This problem is illustrated in FIG. 1, wherein a plurality of users having different service providers are depicted. These users include AT&T Wireless users 1 and 2, Verizon Wireless users 1 & 2, Voicestream users 1 & 2, and Sprint PCS users 1 and 2.

Text messages are commonly sent using the short messaging service (SMS) protocol. In many instances, the user of a particular wireless service provider will only be able to send text messages to other users who use the same provider. For example, AT&T user 1 can send a text message as an SMS message to AT&T user 2 via wireless communication paths 10 and 12. Path 10 comprises the route from a cellular phone 14 that uses AT&T wireless for its service provider to an AT&T wireless short messaging service center (SMSC) 16 via a cellular antenna 18. Path 12 comprises the route from AT&T wireless SMSC 16 via cellular antenna 18 to a cellular phone 20 that also uses AT&T wireless as its service provider. As will be recognized by those skilled in the art, the actual connection path from a cellular phone to another cellular phone and/or an SMCS may comprise several cellular antennas; however, for simplicity, each of the connection paths described herein comprise only a few cellular antennas at most.

In addition to paths 10 and 12, there are other paths illustrated in FIG. 1 that successfully link users operating phones having a common service provider, including paths 22 and 24, which enables Verizon user 1 to send an SMS message from a cellular phone 26 via cellular antenna 18, a Verizon SMSC 28, and a cellular antenna 30 to a cellular phone 32 operated by Verizon user 2. Similarly, paths 32 and 34 enable SMS messaging between cellular phones 36 and 38 respectively operated by Voicestream users 1 and 2 via cellular antennas 18 and 30 and a Voicestream SMSC 40, while paths 42 and 44 enable SMS messaging between PCS phones 46 and 48 via cellular antennas 18 and 30 and a Sprint PCS SMSC 50.

Although there are instances in which service providers provide some cross-compatibility for SMS messaging, there are many markets in which the user audience for SMS messaging is greatly restricted to only those users who have the same service provider. For example, AT&T wireless user 1 may not be able to send SMS messages to any Verizon user, any Voicestream user, or an Sprint PCS user, as provided by failure paths 52, each of which is depicted as a dashed line with an “X” in FIG. 1. Similar failure paths 52 are shown in the Figure to illustrate the lack of cross-compatibility for SMS messaging when the sending phone and the receiving phone use different service providers.

It is clear that the present scheme is inadequate for many users. It would therefore be desirable to provide a scheme that would provide a much higher degree of cross-compatibility for SMS messaging between users having different service providers. Furthermore, it would be preferable that the scheme may be implemented without requiring changes to the existing wireless services infrastructure.

### SUMMARY OF THE INVENTION

The present invention addresses the foregoing cross-connectivity problem by providing a method and system that enables wireless device users to send messages from their devices to other destination wireless devices that use a different service provider than the sending device. Typical sending and destination devices include cellular phones, pagers, wireless PDA's, Pocket PC's, and wireless laptops. In addition, the invention enables messages to be sent from wireless devices to e-mail addresses. Generally, the method and system are enabled through use of a third party rerouting/reformatting service that appears transparent to the wireless device users and service providers, although such functionality may also be provided directly by one or more wireless service providers.

In one embodiment, the method includes converting an original SMS message into an e-mail message and routing the e-mail message to the message rerouting service, whereupon the e-mail message is reformatted into a destination message (as necessary) that is dispatched for delivery to a destination device selected by a user who generated the original SMS message. The method begins by enabling the user to generate an original short messaging service (SMS) message on a sending wireless device and request the message be sent to a selected destination wireless device. In response to an activation cue, such as the user depressing a “SEND” key, an e-mail message comprising content corresponding to the original SMS wireless message and including indicia identifying the destination wireless device is automatically generated and sent to the message rerouting service. Upon reaching the message rerouting service, the e-mail message is parsed to determine a wireless access point for the destination wireless device, which will typically comprise a phone number if the destination device is a cellular phone or pager, or may comprise an IP address. The wireless access point may be embedded in the body or address of the e-mail message, or such information may be retrieved from a database operated by the message rerouting service using search criteria based in part on indicia contained in the e-mail message or address. Based on the wireless access point, one or more service providers that provide infrastructure for routing messages to the wireless access point are determined, and a destination message is generated from the content of the e-mail message. The destination message is then dispatched from the message rerouting service to be delivered to the destination wireless device via message routing infrastructure provided by the previously-identified service providers. In general, the destination message will be formatted based on the particular requirements for those service providers that enable the delivery of the destination message to the destination device. For example, if the destination device is a cellular phone or pager, the e-mail message is reformatted into an SMS message. Other types of destination messages include e-mail messages and instant messages.

In another embodiment, an SMS message is rerouted to the message rerouting service, which again performs reformatting (as necessary) and message dispatch functions to deliver the message to a selected destination device. In this embodiment, rerouting indicia is appended to an original SMS message generated by a user with the sending device, causing the original SMS message to be sent to the rerouting service via an SMSC operated by a service provider for the sending wireless device rather than attempting to directly send the message to the destination device. Upon reaching the rerouting service, various routing indicia are extracted from the SMS message, and a destination message is generated and dispatched for delivery to the destination device in a manner similar to that described above.

In accord with other aspects of the invention, methods are provided to enable wireless device users to send text messages to e-mail address using the message rerouting service.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram illustrating the lack of cross connectivity between service providers under the present wireless message delivery infrastructure;

FIG. 2A is a schematic diagram illustrating a system infrastructure for implementing a first method for rerouting a wireless message in accord with the present invention;

FIG. 2B is a schematic diagram illustrating a system infrastructure for implementing a second method for rerouting a wireless message in accord with the present invention;

FIG. 3A is a schematic diagram illustrating further details of the system infrastructure of FIG. 2A;

FIG. 3B is a schematic diagram illustrating further details of the system infrastructure of FIG. 2B;

FIG. 4A is a flowchart for illustrating the logic used by the present invention in performing the first method for rerouting a wireless message;

FIG. 4B is a flowchart for illustrating the logic used by the present invention in performing the first method for rerouting a wireless message;

FIG. 5 is a representation of an exemplary user interface for implementing a sign-up process with the message rerouting/reformatting service of the invention;

FIG. 6 is an entity relationship diagram corresponding to an exemplary database schema for implementing the database aspects of the invention; and

FIG. 7 is a schematic drawing of a computer system that may be implemented for various components in the system of the present invention.

### DETAILED DESCRIPTION

The present invention provides a method and system that enables wireless device users to send messages from their devices to other wireless devices that use a different service provider than the sending device. In the following description, numerous specific details are provided, to provide a thorough understanding of embodiments of the invention. One skilled in the relevant art will recognize, however, that the invention can be practiced without one or more of the specific details, or with other methods, components, etc. In other instances, well-known structures or operations are not shown or described in detail to avoid obscuring aspects of various embodiments of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

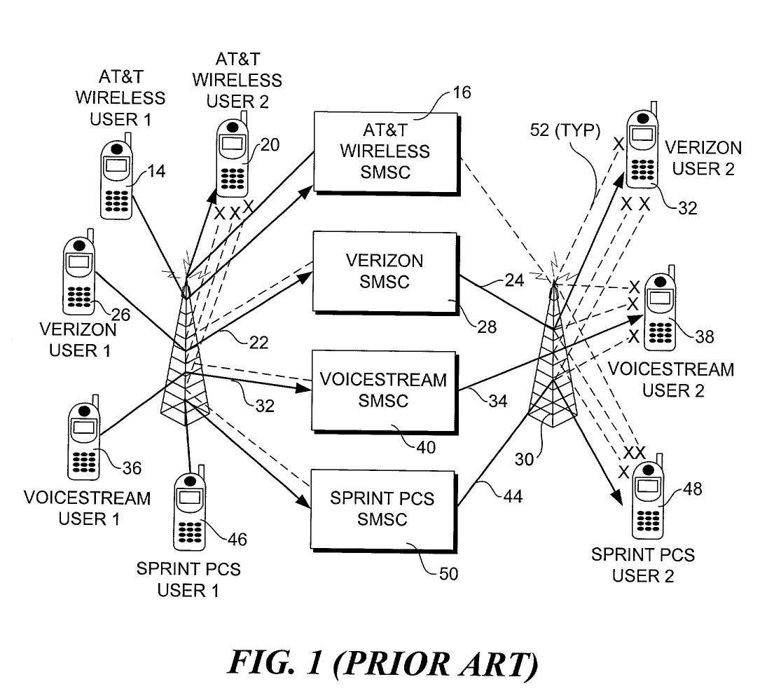

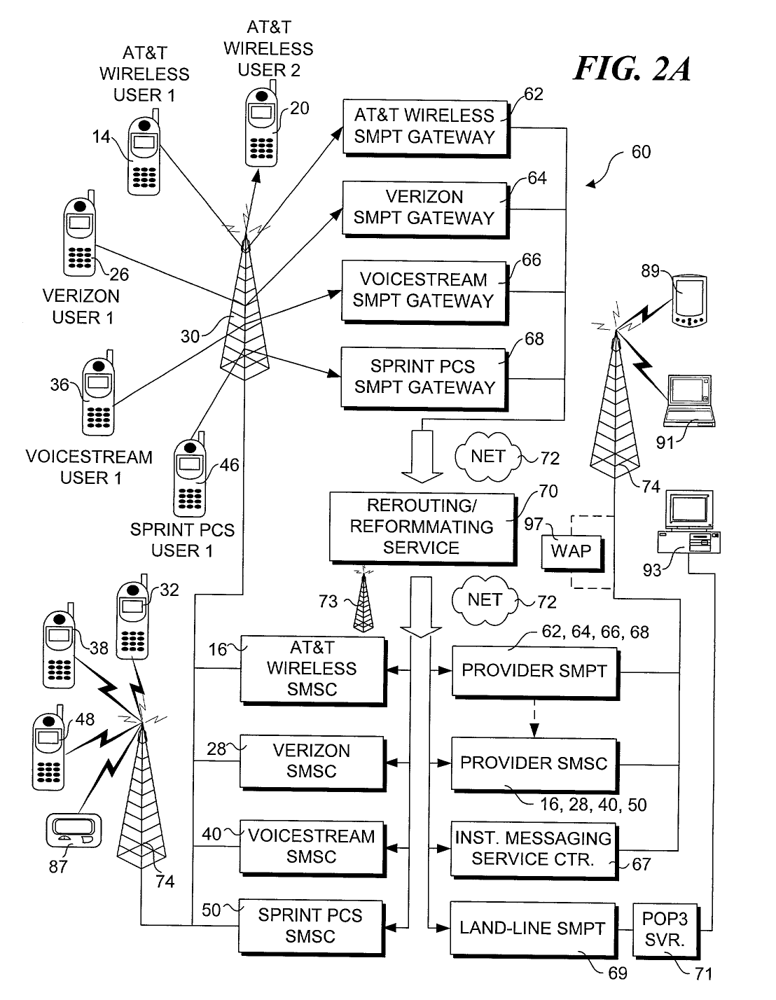

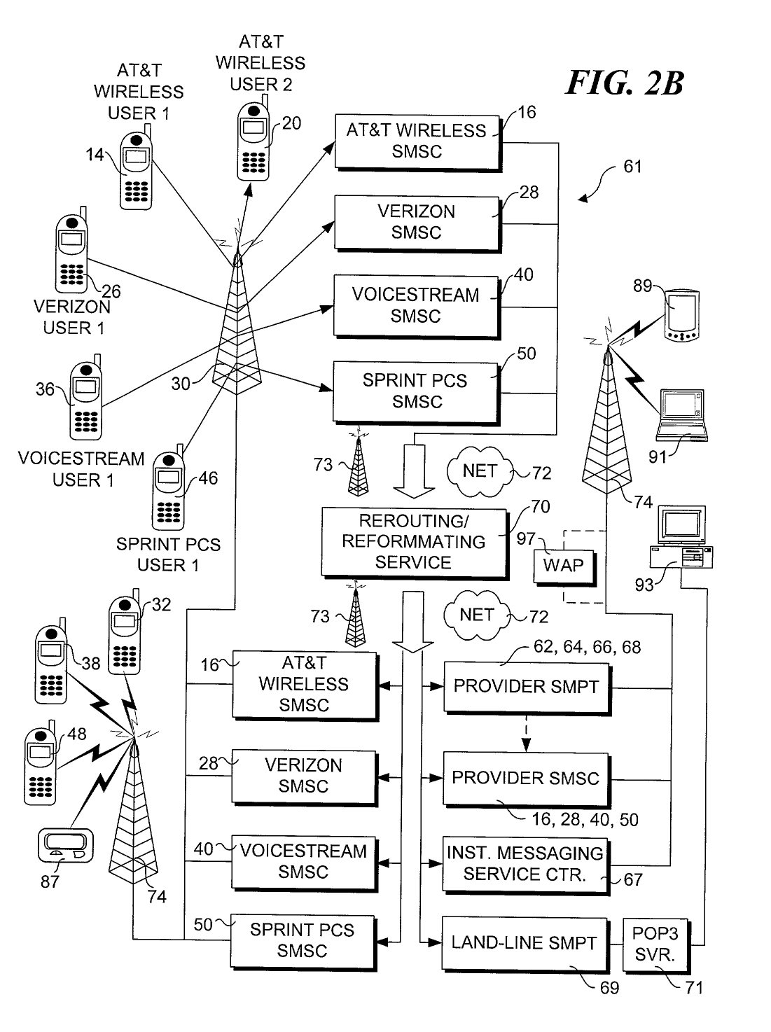

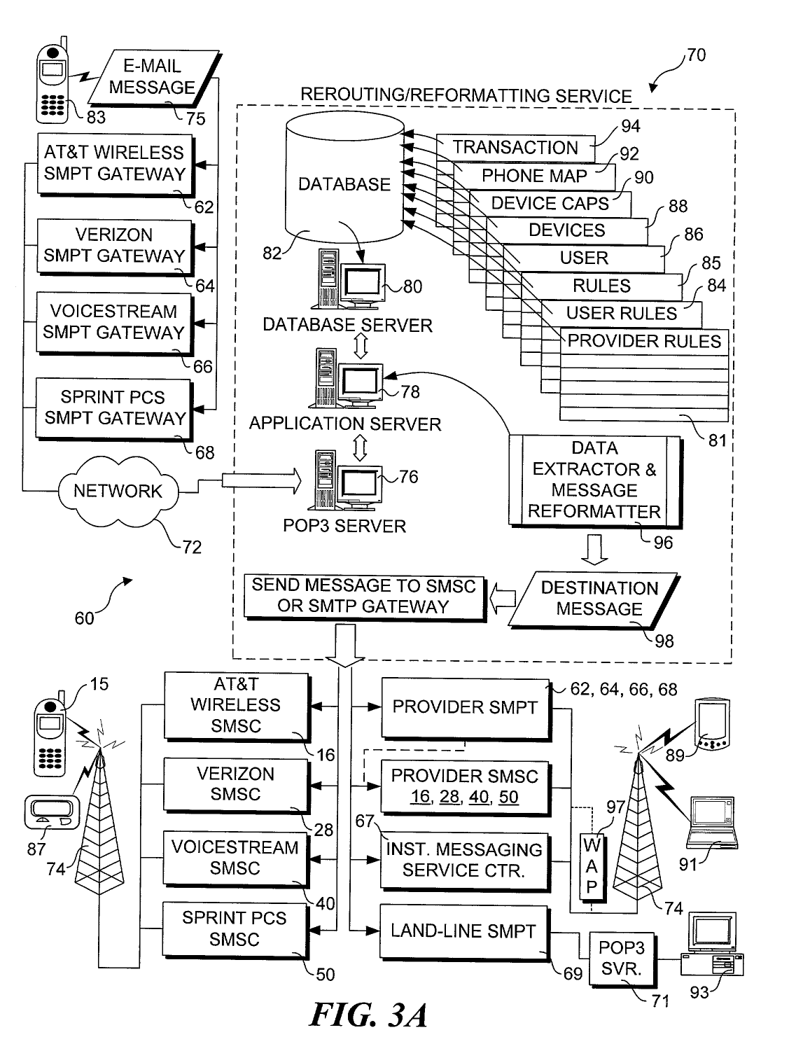

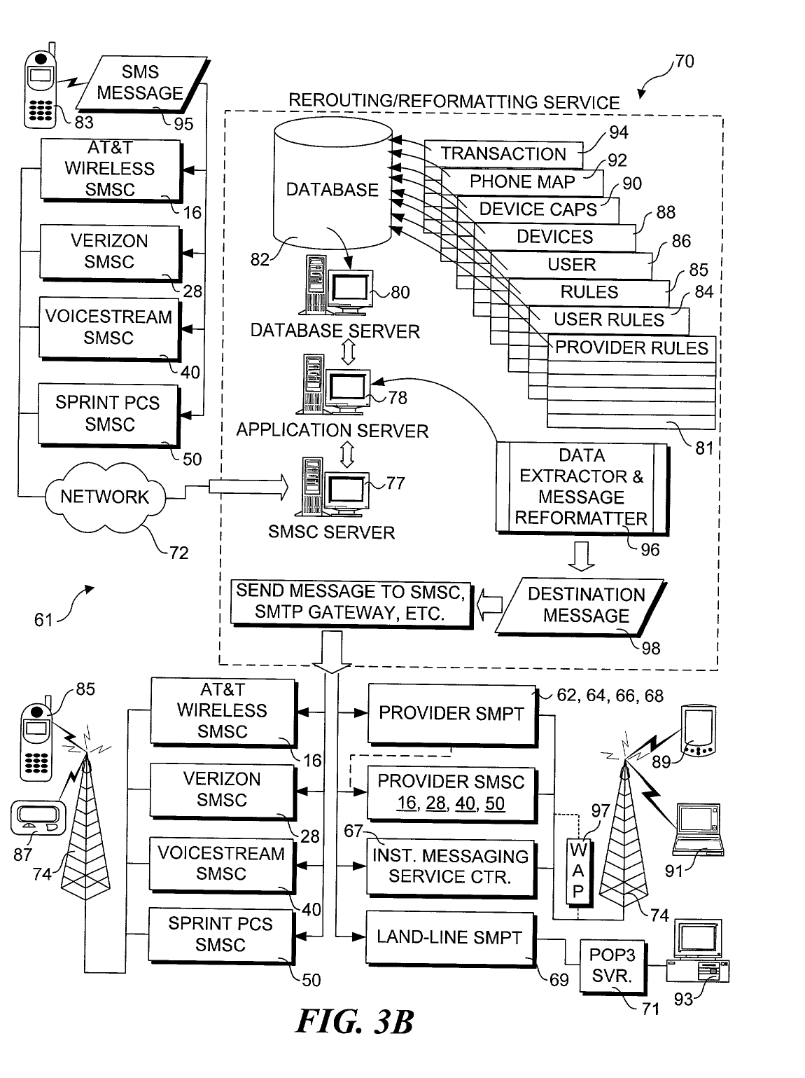

An exemplary system 60 for implementing a first method for rerouting messages in accord with the present invention is shown in FIGS. 2A and 3A. As will be recognized by those skilled in the art, FIG. 2A depicts various conventional wireless infrastructure components, including all of the infrastructure components illustrated in FIG. 1 and discussed above, wherein like-numbered components perform substantially the same functions in both infrastructures. The infrastructure of FIG. 2A further includes a plurality of SMTP (simple mail transport protocol) gateways corresponding to various service providers, including an AT&T Wireless SMTP gateway 62, a Verizon SMTP gateway 64, a Voicestream SMTP gateway 66, and a Sprint PCS gateway 68. It is noted that SMTP gateways 62, 64, 66, and 68 are depicted twice in each of FIGS. 2A and 3A to enable the routing of messages to be depicted more clearly. It will be understood, that these SMPT gateways may represent the same or separate facilities, depending on the locations of the sending and receiving wireless devices. In addition to the foregoing conventional wireless infrastructure components, the system further includes a third party message rerouting/reformatting service 70 that provides various services for facilitating text message cross-compatibility between the various service providers.

The primary components used by rerouting/reformatting service 70 are depicted in FIG. 3A. Rerouting/reformatting service 70 is connected to SMTP gateways 62, 64, 66, and 68 via a network 72. In general, the connection to network 72 will be a land-based connection, although it may be a wireless connection as well. Rerouting/reformatting service 70 is also linked in communication with SMSCs 16, 28, 40, and 50 via either a land-based link or a wireless link.

Rerouting/reformatting service 70 receives incoming e-mail messages 75 forwarded by SMTP gateways 62, 64, 66, and 68 at a POP3 (Post Office Protocol) server 76. Preferably, communication with POP3 server 76 will be enabled through one or more URLs that are used as access points to rerouting/reformatting service 70. POP3 server 76 is connected in communication with an application server 78, which in turn is connected in communication with a database server 80. As will be understood by those skilled in the art, each of POP3 server 76, application server 78, and database server 80 may run on one or more separate machines in a distributed multi-tier environment, or may be run on two machines, or even a single machine. For instance, it is common to use a single machine to perform e-mail server and application server functions.

Preferably, database server 80 will comprise a relational database management system (RDBMS) database server, such as the SQL (structured query language) database servers provided by Oracle (Oracle 8i), Microsoft (SQLserver), Informix, IBM (DB2), or Sybase. Database server 80 operates on data stored in a database 82 having an exemplary schema that includes a provider rules table 81, a user rules table 84, a rules definition table 85, user table 86, a devices table 88, a devices capability table 90, a phone number-to-service provider mapping (phone map) table 92, and a transaction table 94

Application server 78 includes one or more software modules comprising a data extractor and message reformattor 96 that generates destination messages 98 based on corresponding e-mail messages 75 and data stored in database 82. Messages 98 are reformatted to meet the particular requirements of the service provider for a selected destination device, capabilities of the destination device, and any applicable rules corresponding to the initial sender user and/or the service provider. Messages 98 are then sent to a selected destination device via one or more service provider facilities depending on the capabilities of the destination device and other information stored in database 82, further details of which are discussed below.

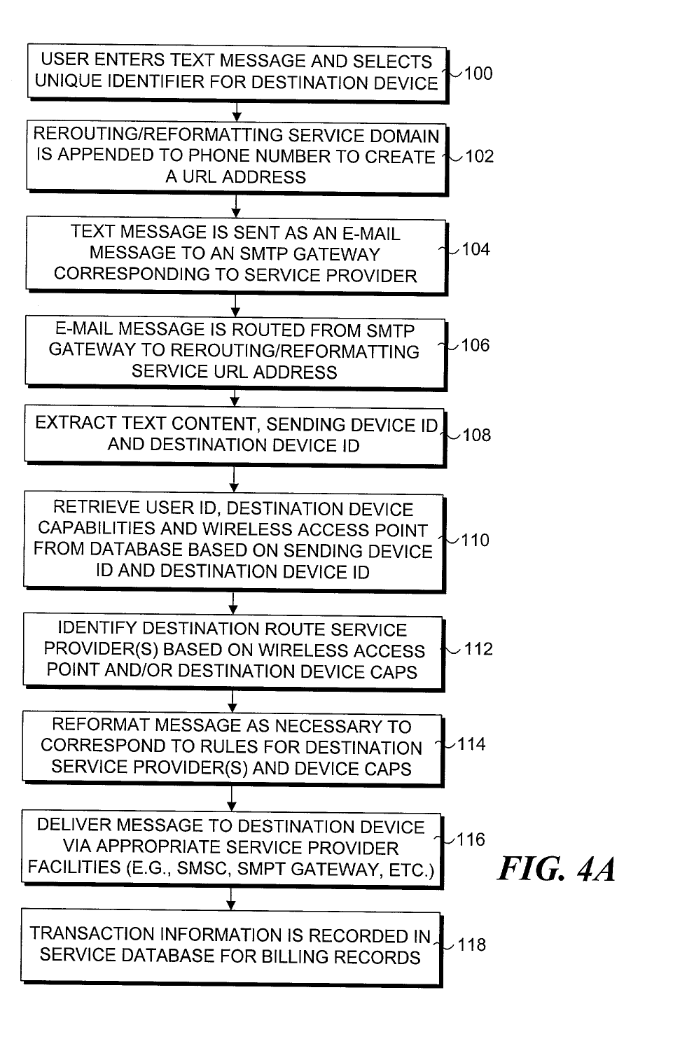

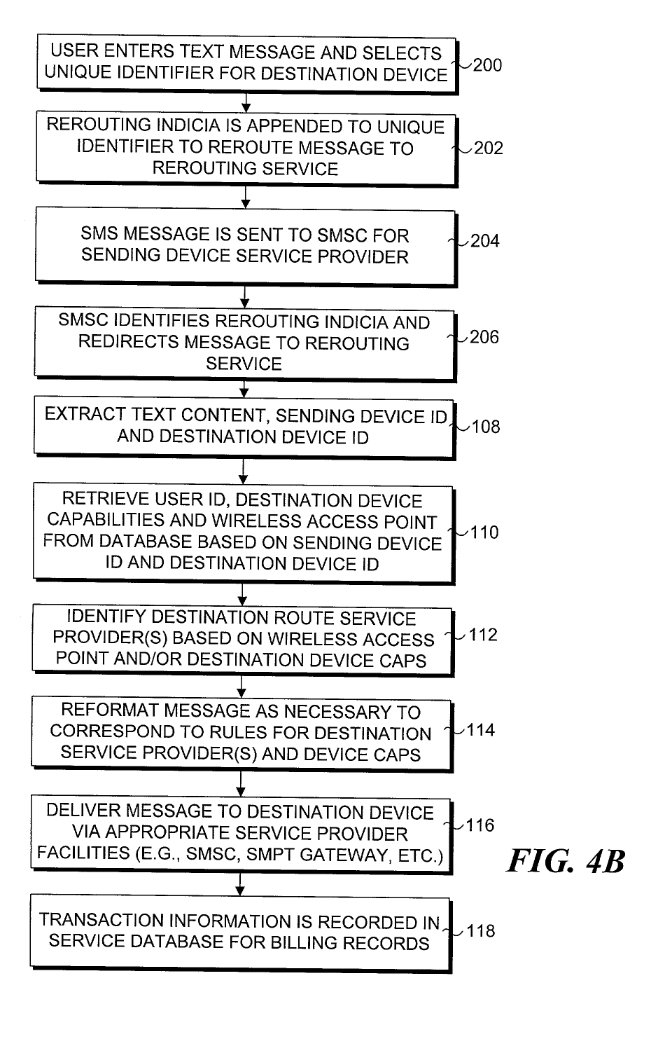

A flowchart corresponding to a method for rerouting messages that is enabled by the system infrastructure of FIGS. 2A and 3A is shown in FIG. 4A. The method begins in a block 100, wherein a user operating a sending wireless device 83 enters a text message and selects a unique identifier corresponding to a destination device the user desires the message to be delivered to. The unique identifier may comprise a telephone number for the destination device, if the device is a wireless phone or pager, or may comprise some other unique identifier corresponding to other destination devices previously registered by the user with rerouting/reformatting service 70, further details of which are discussed below.

Next, in a block 102, a Internet domain name corresponding to one or more Internet domains registered by rerouting/reformatting service 70 is appended to the unique identifier so as to form an e-mail delivery address. For example, suppose the unique identifier is 425.555.1212 and the domain name is “ondevice.com.” The resulting e-mail address will then be “425.555.1212@ondevice.com.”

There are several ways in which the domain name may be appended to the unique identifier. Preferably, this will be performed at the user device, wherein the device, such as a cellular phone, will be programmed to append the domain name in response to a menu option or key sequence entered by the user. Adding a feature of this type to a cellular phone may be accomplished by adding circuitry to an existing cellular phone, including the functionality in a new cellular phone, providing the functionality via a downloaded upgrade, or through other means that will be known to those skilled in the wireless device arts.

The text message is then sent as an e-mail message 75 to an SMTP gateway corresponding to the service provider of the user's device in a block 104. In general, each service provider will operate one or more SMTP gateways, or may share a SMTP gateway with one or more other providers. For simplicity, the configuration depicted in FIGS. 2A and 3A show a single SMTP gateway for each wireless service provider.

In a block 106 the e-mail message is routed from the SMTP gateway via network 72 to POP3 server 76 at rerouting/reformatting service 70 based on the URL for the e-mail message. In addition, the message may traverse one or more other SMPT servers (not shown) along its route to POP3 server 76. Once received by web server 76, the text content, a sending device identifier (ID), and destination device identifier (ID) are extracted in a block 108. Typically, if the sending device is a cellular or PCS phone, the sending device ID will comprise the phone number for the device. This phone number may be identified using an automatic number identification (ANI) system, or it may be automatically appended to the message text via functionality built in to the sending device and extracted by data extractor and message reformatter 96. Similarly, the destination device ID may comprise the portion of the URL prior to the “@domain name” (hereinafter referred to as the prefix), such as might be the case if the destination device was a wireless phone or pager.

In some instances, the user may desire to send the text message to a PDA device (e.g., palm pilot), a handheld computer, or a PC e-mail account rather than a wireless phone or pager. In these instances, the user will generally have registered one or more of these types of devices with rerouting/reformatting service 70, and device IDs for those devices will be stored in database 82. Accordingly, the selected device may be determined based on indicia in the prefix of the e-mail address in optional combination with the sending device phone number or other indicia contained in e-mail message 75 or the e-mail address.

Once the sending and destination device IDs have been extracted, the user ID and capability information corresponding to the destination device are retrieved from database 82 in a block 110 based on identification of the sending device and the destination device ID. In addition, a wireless access point for the destination device is retrieved. The wireless access point is an end point that messages need to reach or be directed to so that the destination device can access those messages. The wireless access point for a cellular phone or page will typically comprise the phone number for those devices. The wireless access points for wireless PDA's, pocket PCs and laptops will typically comprise an IP address or a URL for a wireless Internet service provider for those devices.

The service provider(s) for enabling a destination message to reach the destination device is/are then identified in a block 112 based on the wireless access point and/or the destination device capabilities determined above. For instance, if the destination device is a cellular phone or pager, data contained in phone map table 92 and/or one or more remote database tables that contain phone number-to-service provider mapping information may be queried to retrieve the service provider for the destination. Based on the service provider(s), the capabilities of the destination device, and any preferences entered by the user, data extractor and message reformatter 96 will reformat e-mail message 75 in a block 114 to produce a destination message 98. In more detail, destination message 98 will be reformatted, as necessary, based on the capabilities of the destination device stored in the device capabilities table 90, preferences entered by the user stored in rule definitions table 85, user table 86, and/or device capabilities table 90, and rules for the service provider that preferably are stored in provider rules table 83 and/or rule definition table 85 rules table 84. Generally, destination message 98 will comprise an SMS message, an e-mail message, or an instant message.

Depending on the type of destination device and/or applicable rules, destination message 98 will generally be forwarded to an appropriate service provider facility and/or other service facility in a block 116, via either a land-based network 72 or a wireless network link. For instance, if the message is to be received as a text message by a wireless destination device such as a wireless phone 15 or a pager 87 and the service provider is AT&T wireless, the message will be formatted to correspond with any applicable protocol required by the SMS messaging services provided by AT&T wireless, and forwarded to AT&T wireless SMSC 16, along with the phone number for the destination device, whereupon AT&T wireless SMSC 16 will send the message to the destination device via a wireless antenna 74.

If the message is to be sent to a PDA 89, a pocket PC (not shown), or a wireless-enabled laptop 91, destination message 98 will generally be delivered to an appropriate SMTP gateway for the destination device's carrier. If the destination device supports instant messaging chat session, destination message 98 may be routed through an instant messaging service center 67. In other instances, the message may be first routed through a service provider SMPT, and then routed through a service provider SMSC. In addition, if the destination device is a WAP (wireless access protocol)-enabled device, the destination message may be routed through a WAP gateway 97.

In some instances, the user will desire to send the message to a general e-mail address that may be access by both wireless and land-based devices, such as a land-line computer 93. Accordingly, destination message 98 will be sent to a land-line SMPT 69 and a POP3 server 71 corresponding to the domain that services the e-mail address. For example, if the e-mail address is serviced by Earthlink, destination message 98 is sent to an SMPT operated by Earthlink (or operated by another for the purposes of supporting Earthlink e-mail accounts, and passed to an Earthlink POP3 server.

In addition to the foregoing process functions, transaction information may be recorded in database 82 in a block 118 for billing records and/or royalty records, further details of which are discussed below.

An exemplary system 61 for implementing a second method for rerouting messages in accord with the present invention is shown in FIGS. 2B and 3B. System 61 is substantially similar to system 60, wherein like-numbered components perform substantially the same functions in both infrastructures.

With reference to the flowchart of FIG. 4B, the method begins in a block 200 wherein a user operating a sending device 83 enters a text message and selects a unique identifier for the destination device, in a manner similar to that described above with reference to block 100 of FIG. 4A. Typically, if the destination device is a cellular phone or pager, the unique identifier will be the phone number of the destination device. In response to a user activation cue, such as pressing the send button on a wireless phone, rerouting indicia is appended to the unique identifier or SMS message 95 in a block 202, and the SMS message is dispatched for delivery to the destination device in a block 204.

The rerouting criteria will typically comprise an alphanumeric code, such as an unassigned area code or other combination of alphanumeric characters. The purpose of the rerouting indicia is to inform the service provider for sending device 83 that SMS message 95 is to be delivered to rerouting/reformatting service 70 rather then attempting to deliver the message directly to the destination device. Accordingly, upon receiving SMS message 95, the SMSC identifies the rerouting indicia and redirects SMS message 95 to an SMSC server 77 operated by rerouting/reformatting service 70. SMSC server 77 then forwards SMSC message 95 to application server 78, whereupon the delivery of the message is completed by the functions in blocks 108, 110, 112, 114, 116, and 118, which are performed in substantially the same manner described above with respect to the flowchart of FIG. 4A.

It is noted that although rerouting/reformatting service 70 is depicted as a separate entity in the Figures attached hereto, such functionality may be performed by a service provider. Accordingly, in instances where a service provider provides the functionality of rerouting/reformatting service 70, there will be no need to send messages between the service provider and rerouting/reformatting service 70.

To take advantage of all of the services provided by rerouting/reformatting service 70, users must first register with the service. It will be understood that it is not necessary to register with the service to receive messages, and that alternate registration methods may be employed, such as sign up through a service provider, in addition to the following exemplary sign-up scheme. Preferably, the sign-up process will be facilitated through the web site provided by rerouting/reformatting service 70, although other forms of sign-up may also be used, such as via e-mail, mail, telephone calls, etc.

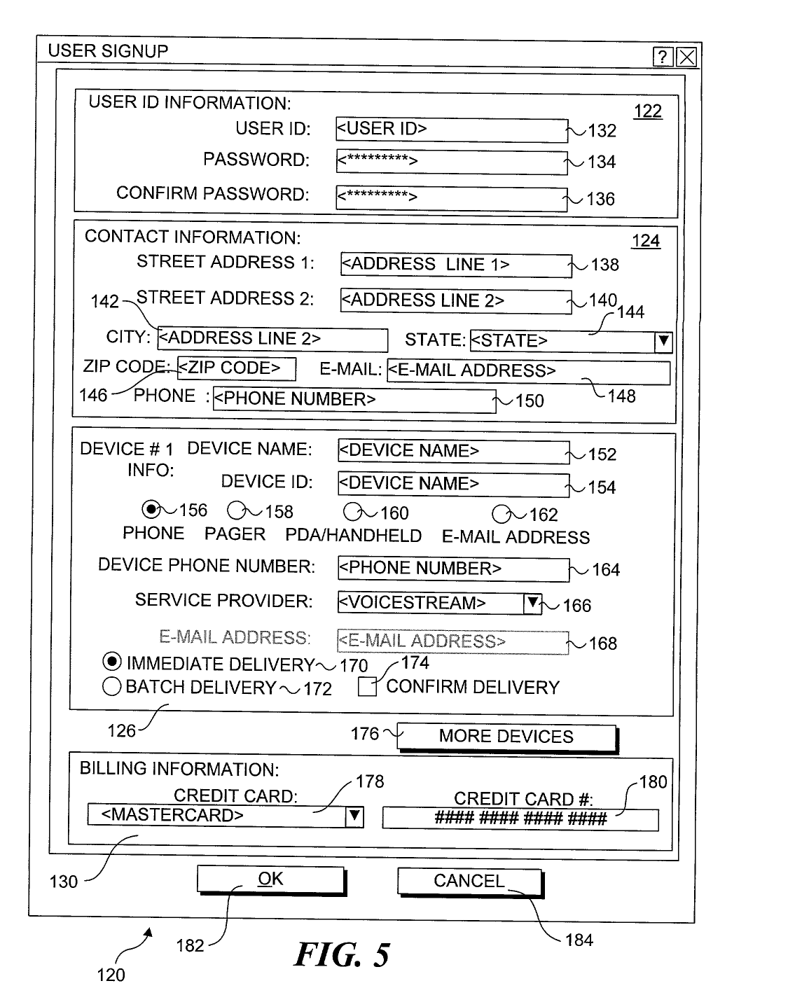

An exemplary sign-up form 120 is shown in FIG. 5. Sign-up form 120 includes a user information section 122, a contact information section 124, a first device information section 126, and a billing information section 130. User information section 122 includes a user ID edit box 132, a password edit box 134, and a password confirmation edit box 136. The user will enter a user ID that will be compared to user IDs that have been previously entered through a check of user table 86. The user's password will be verified through data entered in edit boxes 134 and 136.

The user will enter contact information via a first address line edit box 138, a second address line edit box 140, a city edit box 142, a state dropdown control 144, a zip code edit box 146, and e-mail edit box 148, and a phone number edit box 150.

Next, the user will enter information corresponding to one or more devices the user wishes to have messages delivered to, beginning with information corresponding to a first device in section 126. This section includes a device name edit box 152, a device identification edit box 154, a first radio button group comprising a “PHONE” radio button 156, a “PAGER” radio button 158, a “PDA/HANDHELD” radio button 160, and an “E-MAIL” radio button 162, a device phone number edit box 164, a service provider dropdown control 166, an e-mail address edit box 168, a second radio button group comprising an “IMMEDIATE DELIVERY” radio button 170 and a “BATCH DELIVERY” button 172, and a “CONFIRM DELIVERY” checkbox 174. Depending on the type of device selected, various other edit boxes will be grayed.

The user will enter a device name in edit box 152 and a device ID in edit box 154. Preferably, data in edit box 154 will automatically be populated with a sequence number upon entry of a new device. The user will select a device from among radio buttons 156, 158, 160, and 162, and enter a device phone number in edit box 164, if appropriate. Preferably, if the device has a corresponding phone number, the user will enter a service provider for the device via service provider dropdown control 166, although this will be optional. If the selected device is an e-mail address, edit boxes 164 and 166 will be grayed, and the user will enter the e-mail address in edit box 168. The user may choose the type of delivery for the message by selecting either “IMMEDIATE DELIVERY” radio button 170 or “BATCH DELIVERY” radio button 172. The user may also choose to have a confirmation of delivery message sent to the user's e-mail address by selecting “CONFIRM DELIVERY” checkbox 174. The various delivery options correspond to delivery rules that are stored rule definition table 85, and the selected rules are stored in user rules table 84 for each user. In addition to the delivery options shown in the Figure, other user-defined rules may also be implemented.

If the user desires to register additional devices, the user will activate a “MORE DEVICES” button 176, which will launch a dialog box containing edit boxes and dropdown controls for entering information for these devices.

It is envisioned that rerouting/reformatting service 70 will derive revenue through subscription services and/or partnerships with various web sites and wireless service providers. In the case of subscription services, the user will be required to enter billing information, including selecting a credit card from a dropdown control 178 and entering a corresponding credit card number in an edit box 180. After filling out signup form 120, the user will activate an “OK” button 182 to proceed with the sign up process. The user may cancel the sign-up process at any time by activating a “CANCEL” button 184.

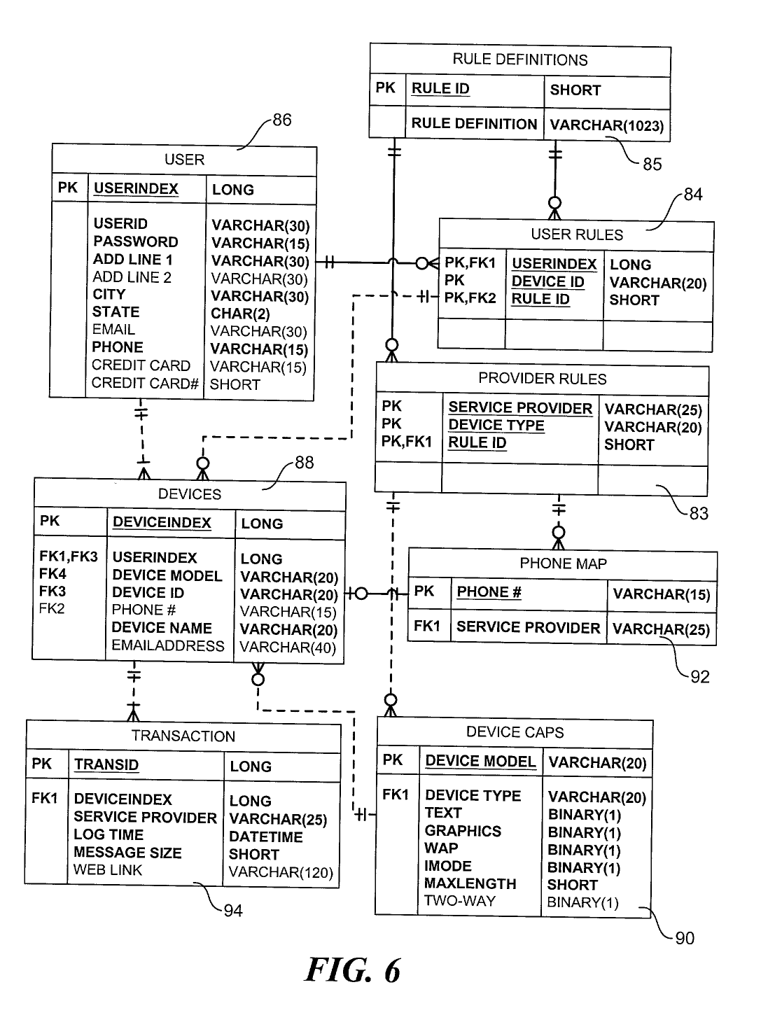

After the user has selected to enter the sign-up information, the information in the various edit boxes and dropdown controls will be entered into appropriate tables in database 82, in accordance with an exemplary entity relationship diagram for the database shown in FIG. 6. For example, the data entered in user ID information section 122, and contact information section 124 are stored in user table 86, while the device information is stored in devices table 88.

In instances in which the device requires a service provider (e.g., cellular phones, pagers, etc.), it will be necessary to identify that service provider. Although this information may be entered by the user during sign-up (or through a subsequent modification to sign-up data), there is no guarantee that this information will be accurate. To ensure accuracy, one or more remote databases will be used to match up phone numbers with service providers. This information will be stored in phone map table 92. Preferably, the proper service provider will be confirmed by sending a “ping” message to the user's device.

As discussed above, certain service providers will have particular content formatting rules. The applicable rules for each service provider/device combination may be stored through the combination of provider rules table 81 and rules definition table 85. As will be recognized by those skilled in the art, similar rules and indicators to apply such rules for particular service providers and/or devices may be stored in one or more datafiles that are accessible to applications running on application server 78, or stored in other tables in database 82. Preferably, any applicable rules for a given message will be extracted by data extractor and message reformatter 96 and applied when generating destination message 98, and delivery options and/or other rules will be applied to ensure proper delivery of the message.

Information concerning the capabilities of each device is stored in the device capabilities table 90. This information can be extracted through data retrieved from the service providers (e.g., characteristics of devices by model number). Optionally, additional fields can be added to sign-up form 120 to identify the model and make of each device.

It will be understood by those skilled in the art that the database schema shown in FIG. 6 is exemplary; the actual scheme used will generally include several other tables, and the tables shown may further include additional attributes. For example, in the entity relationship diagram of FIG. 6, rule definitions are stored in a table that is separate from the user rules and provider rules table, each of which are configured to identify a set of rules that are to be applied for each user and each service provider/device type combination. The rules and indication data for when that are to be applied may be stored in the same table, and provider rules may be applicable to certain types of messages, particular device models, or other criteria.

Exemplary Machine for Implementing Various System Functions

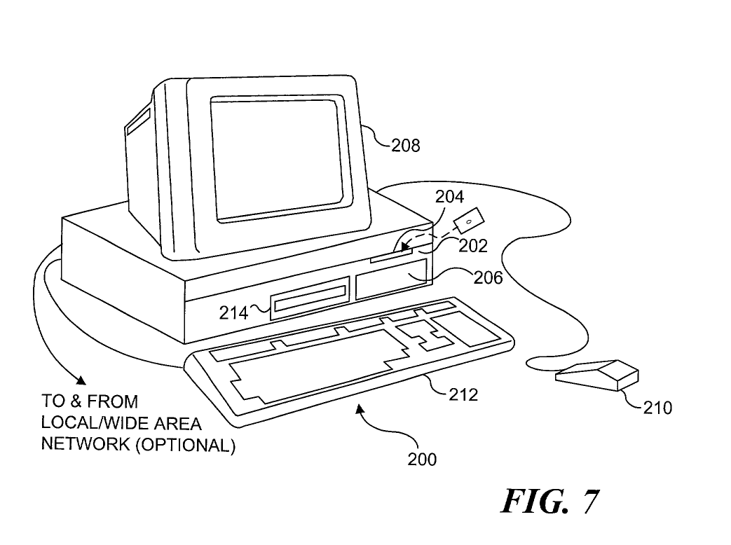

With reference to FIG. 7, a generally conventional personal computer 200 is illustrated, which is suitable for use in connection with practicing the present invention. Alternatively, a corresponding workstation on a local area network may be used for executing machine instructions comprising a computer program that causes the present invention to be executed. Personal computer 200 includes a processor chassis 202 in which are mounted a floppy disk drive 204, a hard drive 206, a motherboard populated with appropriate integrated circuits (not shown), and a power supply (also not shown), as are generally well known to those of ordinary skill in the art. A monitor 208 is included for displaying graphics and text generated by software programs that are run by the personal computer, and for graphically representing images and video frames produced by the present invention. A mouse 210 (or other pointing device) is connected to a serial port (or to a bus port) on the rear of processor chassis 202, and signals from mouse 210 are conveyed to the motherboard to control a cursor on the display and to select text, menu options, and graphic components displayed on monitor 208 by software programs executing on the personal computer, such as a photo editing program that implements the present invention. In addition, a keyboard 212 is coupled to the motherboard for user entry of text and commands that affect the running of software programs executing on the personal computer.

Personal computer 200 also optionally includes a compact disk-read only memory (CD-ROM) drive 214 into which a CD-ROM disk may be inserted so that executable files and data on the disk can be read for transfer into the memory and/or into storage on hard drive 206 of personal computer 200. Other mass memory storage devices such as an optical recorded medium or DVD drive may be included. The machine instructions comprising the software program that causes the CPU to implement the functions of the present invention that have been discussed above will likely be distributed on floppy disks or CD-ROMs (or other memory media) and stored in the hard drive until loaded into random access memory (RAM) for execution by the CPU.

Machines similar to computer 200 may be used for the various servers in the system. However, it is preferable that machines that are designed specifically for file and application server functions be implemented as such.

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. Accordingly, it is not intended that the scope of the invention in any way be limited by the above description, but instead be determined entirely by reference to the claims that follow.

What is claimed is:

1. A method for rerouting a wireless message comprising:
enabling a user to generate an original short messaging service (SMS) message on a sending wireless device and request the message be sent to a destination wireless device having a service provider that is different than that used for the sending wireless device;
automatically generating an e-mail message comprising content corresponding to the original SMS wireless message and including indicia identifying the destination wireless device;
sending the e-mail message to a message rerouting service;
determining a wireless access point for the destination wireless device;
determining one or more service providers that provide infrastructure for routing messages to the wireless access point;
generating a destination message from the content of the e-mail message; and
dispatching the destination message to be delivered to the destination wireless device via message routing infrastructure provided by said one or more service providers.

2. The method of claim 1, wherein the destination device comprises a one of a cellular phone or pager having a phone number, and the user generates and sends the original SMS wireless message in a conventional matter by sending the message to the phone number of the destination wireless device.

3. The method of claim 1, wherein automatically generating the e-mail message and sending it to the message rerouting service comprises:
generating an e-mail address corresponding to a domain operated by the message rerouting service;
adding text and/or data content from the original SMS message to an e-mail message; and
sending the e-mail message to a simple mail transport protocol (SMTP) gateway operated by a service provider for the sending wireless device.

4. The method 3, wherein the e-mail address is generated by appending an e-mail domain address corresponding to the message rerouting service to the phone number of the destination wireless device.

5. The method of claim 1, wherein the wireless access point comprises a phone number for the destination wireless device, and said one or more service providers are determined by querying one or more phone number-to-service provider databases operated by or accessible to the rerouting service using the phone number as a search criteria.

6. The method of claim 1, further comprising:
determining data handling capabilities of the destination wireless device; and
generating the destination message such that it corresponds to the data handling capabilities of the destination wireless device.

7. The method of claim 1, further comprising:
determining an identification of the sending wireless device; and
recording transactional data corresponding to the rerouting of the wireless message so that the message rerouting service can bill an operator of the sending and/or destination wireless devices.

8. The method of claim 1, further comprising:
determining any wireless messaging rules that are particular to the service provider(s) that are used to route the destination message to the destination wireless device; and
generating the destination message such that it corresponds to those wireless messaging rules.

9. The method of claim 1, wherein the destination device comprises one of a cellular phone or pager and the destination message comprises an SMS message that is routed to the destination device via a short messaging service center (SMSC) operated by a service provider for the destination device.

10. The method of claim 1, wherein the destination device comprises an Internet-enabled wireless device and the destination message comprises an instant message that is routed to an instant messaging service center that provides instant messaging services via an account held by a user of the destination wireless device.

11. The method of claim 1, further comprising enabling users to sign-up with the message rerouting service to have wireless messages they send or are sent by other rerouted to devices that they or others register with the message rerouting service.

12. The method of claim 1, further comprising:
enabling the user to specify delivery preferences for the wireless message; and
delivering the destination message to the destination wireless device based on the delivery preferences specified by the user.

13. A method for rerouting a wireless message comprising:
enabling a user to generate an original short messaging service (SMS) message on a sending wireless device and request the message be sent to a destination wireless device having a service provider that is different than that for the sending wireless device;
appending rerouting indicia to the original SMS message;
sending the original SMS message to a short messaging service center (SMSC) operated by a service provider for the sending wireless device;
redirecting the original SMS message from the SMSC to a rerouting service identified by the rerouting indicia;
determining a wireless access point for the destination wireless device;
determining one or more service providers that provide infrastructure for routing messages to the wireless access point;
generating a destination message based on content contained in the original SMS message; and
dispatching the destination message to be delivered to the destination wireless device via message routing infrastructure provided by said one or more service providers

14. The method of claim 13, wherein the destination device comprises a one of a cellular phone or pager having a phone number, and the user generates and sends the original SMS wireless message in a conventional matter by sending the message to the phone number of the destination wireless device.

15. The method of claim 13, wherein appending rerouting indicia to the original SMS message comprises appending an alphanumeric code to a phone number corresponding to the destination wireless device.

16. The method 15, wherein the alphanumeric code comprises an unused area code.

17. The method of claim 13, wherein the wireless access point comprises a phone number for the destination wireless device, and said one or more service providers are determined by querying one or more phone number-to-service provider databases operated by or accessible to the rerouting service using the phone number as a search criteria.

18. The method of claim 13, further comprising:
determining data handling capabilities of the destination wireless device; and
generating the destination message such that it corresponds to the data handling capabilities of the destination wireless device.

19. The method of claim 13, further comprising:
determining an identification of the sending wireless device; and
recording transactional data corresponding to the rerouting of the wireless message so that the message rerouting service can bill an operator of the sending and/or destination wireless devices.

20. The method of claim 13, further comprising:
determining any wireless messaging rules that are particular to the service provider(s) that are used to route the destination message to the destination wireless device; and
generating the destination message such that it corresponds to those wireless messaging rules.

21. The method of claim 13, wherein the destination device comprises one of a cellular phone or pager and the destination message comprises an SMS message that is routed to the destination device via a short messaging service center (SMSC) operated by a service provider for the destination device.

22. The method of claim 13, wherein the destination device comprises an Internet-enabled wireless device and the destination message comprises an instant message that is routed to an instant messaging service center that provides instant messaging services via an account held by a user of the destination wireless device.

23. The method of claim 13, further comprising enabling users to sign-up with the message rerouting service to have wireless messages they send or are sent by other rerouted to devices that they or others register with the message rerouting service.

24. The method of claim 13, further comprising:
enabling the user to specify delivery preferences for the wireless message; and
delivering the wireless message to the destination wireless device based on the delivery preferences specified by the user.

25. A method for routing a wireless message to an e-mail address comprising:
enabling a user to generate a short messaging service (SMS) message on a sending wireless device and request an e-mail message comprising content corresponding to the SMS message be sent to a destination e-mail address selected by the user;
automatically generating an original e-mail message comprising content corresponding to the SMS message;
sending the original e-mail message to a message rerouting service;
determining the destination e-mail address;
determining one or more service providers that provide infrastructure for routing e-mail messages from the rerouting service to the destination e-mail address;
dispatching the original e-mail message to be delivered to an e-mail server corresponding to the destination e-mail address via e-mail message routing infrastructure provided by said one or more service providers.

26. The method of claim 26, further comprising reformatting the original e-mail message to produce a destination e-mail message from the content of the original e-mail message prior to dispatching the e-mail message for delivery to the destination e-mail address.

27. The method of claim 25, wherein automatically generating the original e-mail message and sending it to the message rerouting service comprises:
generating a rerouting service e-mail address corresponding to a domain operated by the message rerouting service;
adding text and/or data content from the original SMS message to an e-mail message; and
sending the e-mail message to a simple mail transport protocol (SMTP) gateway operated by a service provider for the sending wireless device so that it may be delivered to the domain.

28. The method of claim 27, wherein the destination e-mail address is embedded in the original e-mail message.

29. The method of claim 27, wherein the rerouting service e-mail address comprises a prefix to which the domain is appended to, and the destination e-mail address may be derived from the prefix.

30. The method of claim 25, wherein the rerouting service maintains a database that maps e-mail address to users of the rerouting service, and wherein determining the destination e-mail address is performed by:
enabling the user to include indicia identifying a destination e-mail address the user desires to send the message to contained within or sent with the original SMS message;
determining an identity of the user; and
retrieving the destination e-mail address from the database using the identity of the user and the indicia as a search criteria.

31. The method of claim 25, further comprising:
determining an identification of the sending wireless device; and
recording transactional data corresponding to the rerouting of the wireless message so that the message rerouting service can bill an operator of the sending and/or destination wireless devices.

32. A method for routing a wireless message to an e-mail address comprising:
enabling a user to generate a short messaging service (SMS) message on a sending wireless device and request an e-mail message comprising content corresponding to the SMS message be sent to a destination e-mail address selected by the user;
appending rerouting indicia to the original SMS message;
sending the SMS message to a short messaging service center (SMSC) operated by a service provider for the sending wireless device;
redirecting the SMS message from the SMSC to a rerouting service identified by the rerouting indicia;
automatically generating an e-mail message comprising content corresponding to the SMS message;
determining the destination e-mail address;
determining one or more service providers that provide infrastructure for routing e-mail messages from the rerouting service to the destination e-mail address;
dispatching the e-mail message to be delivered to an e-mail server corresponding to the destination e-mail address via e-mail message routing infrastructure provided by said one or more service providers.

33. The method of claim 32, wherein appending rerouting indicia to the SMS message comprises appending an alphanumeric code to a phone number corresponding to the destination wireless device.

34. The method 33, wherein the alphanumeric code comprises an unused area code.

35. The method of claim 32, wherein the destination e-mail address is embedded in the SMS message.

36. The method of claim 32, wherein the rerouting service maintains a database that maps e-mail address to users of the rerouting service, and wherein determining the destination e-mail address is performed by:
enabling the user to include indicia identifying a destination e-mail address the user desires to send the message to contained within or sent with the original SMS message;
determining an identity of the user; and
retrieving the destination e-mail address from the database using the identity of the user and the indicia as a search criteria.

37. The method of claim 32, further comprising:
determining an identification of the sending wireless device; and
recording transactional data corresponding to the rerouting of the wireless message so that the message rerouting service can bill an operator of the sending and/or destination wireless devices.
